(19) United States
(12) Patent Application Publication
(10) Pub. No.: US 2025/0374913 A1
(43) Pub. Date: Dec. 11, 2025

(54) MOBILE REMOVAL DEVICE

(71) Applicant: FUTABA INDUSTRIAL CO., LTD., Okazaki-shi (JP)

(72) Inventor: Masanori Okada, Okazaki-shi (JP)

(21) Appl. No.: 19/209,085

(22) Filed: May 15, 2025

(30) Foreign Application Priority Data
Jun. 10, 2024 (JP) 2024-093758

(51) Int. Cl. A01M 21/04

(52) U.S. Cl. CPC A01M 21/046

(57) ABSTRACT

Provided is a mobile removal device configured to irradiate, with a laser beam, a hindrance capable of inhibiting plant growth. The mobile removal device includes a camera, a controller, and a guide portion of the laser beam. The guide portion includes a reflector of the laser beam. The controller displaces at least one of the camera and the reflector to thereby transition between an interference state and a non-interference state, the interference state being a state in which the reflector is located within an imaging range of the camera, and the non-interference state being a state in which the reflector does not interfere with a detection of the hindrance based on the captured image taken by the camera. The controller irradiates the hindrance with the laser beam in the interference state and detects the hindrance based on the captured image in the non-interference state.

### CROSS-REFERENCE TO RELATED APPLICATIONS

This application claims the benefit of priority based on Japanese Patent Application No. 2024-093758 filed on Jun. 10, 2024, with the Japan Patent Office, and the entire disclosure of which is incorporated herein by reference.

### BACKGROUND

The present disclosure relates to a mobile removal device configured to remove a hindrance that may inhibit plant growth.

As described in Japanese Unexamined Patent Application Publication No. 2023-116312, a mobile weeder is known which is configured to remove an undesirable plant occurring in agricultural land by irradiating the undesirable plant with a laser beam. The mobile weeder of Japanese Unexamined Patent Application Publication No. 2023-116312 includes a camera for capturing the ground below the device. The mobile weeder grasps a position of the undesirable plant based on a captured image taken by the camera, and emits a laser beam toward the undesirable plant from a laser irradiation device installed at a lower part of a body of the mobile weeder.

### SUMMARY

However, in the mobile weeder of Japanese Unexamined Patent Application Publication No. 2023-116312, a position of the laser irradiation device installed at the lower part of the body of the mobile weeding device is distanced from a position of the camera. Therefore, when an irradiation position of the laser beam is controlled, a correction process may be required with respect to a position determined based on the captured image taken by the camera, and/or an accuracy of the irradiation position may be reduced.

In one aspect of the present disclosure, it is desirable to optimally control the irradiation position of the laser beam.

One aspect of the present disclosure is a mobile removal device configured to irradiate, with a laser beam, a hindrance capable of inhibiting plant growth. The mobile removal device includes a camera, a laser oscillator, a controller, and a guide portion. The camera is configured to capture a ground. The laser oscillator is configured to output the laser beam. The controller is configured to detect the hindrance on the ground based on a captured image taken by the camera and to irradiate the hindrance with the laser beam. The guide portion is configured to guide the laser beam output by the laser oscillator. The guide portion includes a reflector configured to reflect the laser beam. The controller displaces at least one of the camera and the reflector to thereby transition between an interference state and a non-interference state, the interference state being a state in which the reflector is located within an imaging range of the camera, and the non-interference state being a state in which the reflector does not interfere with a detection of the hindrance based on the captured image. The controller is configured to irradiate the hindrance with the laser beam in the interference state, and to detect the hindrance based on the captured image taken by the camera in the non-interference state.

With the above configuration, the hindrance can be optimally detected based on the captured image in the non-interference state. In addition, a reflection position of the laser beam on the reflector in the interference state can be arranged in or close to an imaging range of the camera in the non-interference state. This reduces the processing required to control the irradiation position of the laser beam. Therefore, the irradiation position of the laser beam can be optimally controlled.

In one aspect of the present disclosure, the reflector may be configured to finally reflect the laser beam output by the laser oscillator. The camera may be provided with a wide-angle lens.

With the above configuration, the camera can capture the ground over a larger area.

In one aspect of the present disclosure, the controller may be configured to displace the reflector to thereby transition between the interference state and the non-interference state.

With the above configuration, the interference state and the non-interference state can be optimally switched.

In one aspect of the present disclosure, in the non-interference state, the controller may be configured to detect the hindrance based on an image recognition region in the captured image taken by the camera. In the non-interference state, the controller may be configured to displace the reflector to a non-interference position where the reflector does not appear in the image recognition region of the captured image taken by the camera.

With the above configuration, the hindrance can be optimally detected based on the captured image in the non-interference state.

In one aspect of the present disclosure, a reflection position of the laser beam on the reflector in the interference state may be on or close to an optical axis of the camera.

With the above configuration, the processing required to control the irradiation position of the laser beam can be reduced.

In one aspect of the present disclosure, the controller may be configured to displace the camera to thereby transition between the interference state and the non-interference state.

With the above configuration, the interference state and the non-interference state can be optimally switched.

In one aspect of the present disclosure, the laser beam may be visible light.

With the above configuration, the irradiation position of the laser beam can be optimally controlled.

In one aspect of the present disclosure, the hindrance may be an undesirable plant.

With the above configuration, the plant growth can be suitably promoted.

### BRIEF DESCRIPTION OF THE DRAWINGS

Some embodiments of the present disclosure will be described hereinafter by way of example with reference to the accompanying drawings, in which:

FIG. 1A is an explanatory diagram showing a mobile removal device of a first embodiment as seen from the front;

FIG. 1B is an explanatory diagram showing the mobile removal device and an image recognition region of the first embodiment;

FIG. 2A is an explanatory diagram showing a mobile mirror in the mobile removal device of the first embodiment;

FIG. 2B is an explanatory diagram showing a path taken by the mobile removal device of the first embodiment at the time of performing a weeding operation; and

FIG. 3 is an explanatory diagram showing a fixed mirror in a mobile removal device of a second embodiment.

### DETAILED DESCRIPTION OF EXEMPLARY EMBODIMENTS

### 1. First Embodiment

### (1) Overview

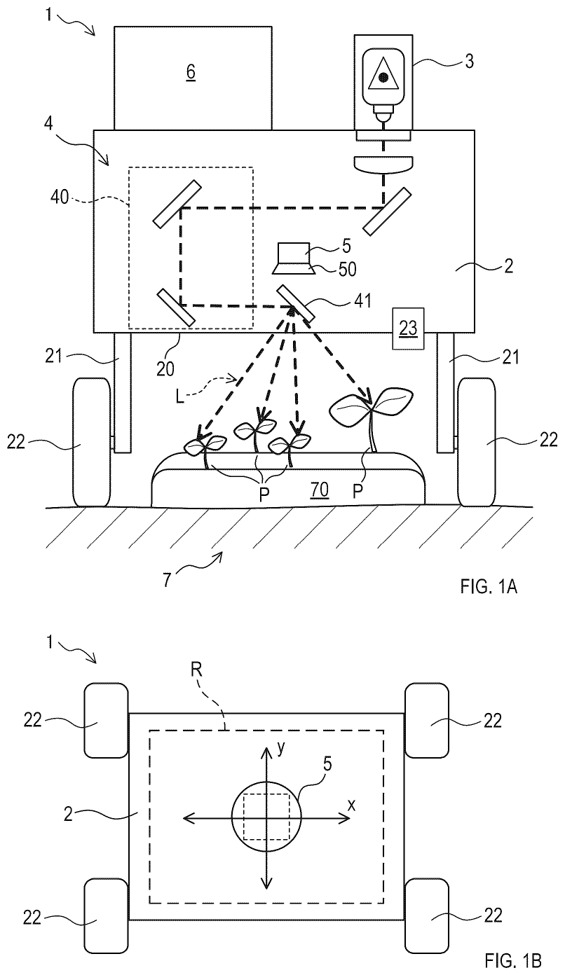

A mobile removal device 1 of the first embodiment is configured to irradiate, with a laser beam L, an undesirable plant P (e.g., a weed) that has grown around a crop 71 in an agricultural land 7 and that may inhibit the growth of the crop 71 to thereby remove the undesirable plant P (see. FIG. 1A). The mobile removal device 1 is movable, and detects the undesirable plant P while moving through the agricultural land and irradiates the detected undesirable plant P with the laser beam L. The mobile removal device 1 includes a main body 2, a laser oscillator 3, a guide portion 4, a camera 5 and a controller 6.

### (2) Main Body

The main body 2 is a housing that holds the laser oscillator 3, the guide portion 4, the camera 5, the controller 6, and a battery or the like that is not shown (see FIG. 1A). The main body 2 is also provided with a plurality of legs 21, a plurality of wheels 22, and an illuminator 23.

The legs 21 are provided around the edge of a lower part 20 of the main body 2, which is a part facing the ground, and protrude downward. The legs 21 are respectively provided with the wheels 22 for moving the mobile removal device 1 at the lower ends of the legs. As an example, these wheels 22 may be driven by a motor that is not shown. Of course, the mobile removal device 1 is not limited to the foregoing, and may be configured to be moved by an operator pushing or pulling the main body 2. The main body 2 may be provided with one or more electric crawlers, for example, instead of the wheels 22.

The illuminator 23 is provided in a lower part 20 of the main body 2 and illuminates an area of the ground below the main body 2.

### (3) Camera

The camera 5 is provided in the lower part 20 of the main body 2 and includes a wide-angle lens 50 (see FIG. 1A). The camera 5 is configured to capture an area of the ground facing the lower part 20, i.e., an area directly below the main body 2, using the wide-angle lens 50 (see FIG. 1B). Of course, the camera 5 is not limited to this configuration, and may also capture the vicinity of the area directly below the main body 2.

In the first embodiment, the position of the camera 5 is fixed. As will be described in more detail below, the mobile removal device 1 detects the undesirable plant P on the ground within an image recognition region R included in an imaging range of the camera 5 and irradiates the undesirable plant P with the laser beam L.

### (4) Laser Oscillator

The laser oscillator 3 is configured to output the laser beam L (see FIG. 1A). As an example, a semiconductor laser may be used as the laser oscillator 3; however, other oscillators that output the laser beam L in various ways may be used without being limited to this configuration.

In the first embodiment, the laser beam L is visible light, for example. More specifically, the laser beam L has a wavelength of 400 nm or more and 550 nm or less, for example, and a blue laser is used as the laser beam L. The blue laser is in a wavelength range where energy is not easily absorbed by water. Thus, the blue laser can efficiently remove a plant even if the plant is covered with water components, such as rain. Of course, the laser beam L is not limited to the foregoing. For example, a laser beam L other than the blue laser and a laser beam L other than the visible light may be used.

### (5) Guide Portion

The guide portion 4 includes a plurality of optical elements and is configured to guide the laser beam L output by the laser oscillator 3 so that the laser beam L is emitted from the lower part 20 of the main body 2 downward to the undesirable plant P located below the main body 2 (see FIG. 1A). Specifically, the guide portion 4 includes two galvanometer mirrors 40 and a movable mirror 41.

The two galvanometer mirrors 40 are arranged side by side and the laser beam L output by the laser oscillator 3 is sequentially reflected by the galvanometer mirrors 40. The two galvanometer mirrors 40 correspond to an x-axis direction and a y-axis direction, respectively. As an example, the y-axis may extend parallel to a direction of travel of the mobile removal device 1 and the x-axis may extend in a direction perpendicular to the direction of travel. Each galvanometer mirror 40 changes its orientation by a galvanometer scanner in accordance with a signal from the controller 6 to thereby change the path of the laser beam L. This displaces an irradiation position of the laser beam L in the corresponding direction. Of course, the number of galvanometer mirrors can be determined as appropriate, and for example, three galvanometer mirrors may be provided.

### (6) Movable Mirror

The movable mirror 41 is configured as a reflector that reflects the laser beam L reflected by the two galvanometer mirrors 40 toward the area of the ground below the main body 2 (see FIG. 1A). That is, the laser beam L output by the laser oscillator 3 is finally reflected by the movable mirror 41 before the laser beam L is emitted from the lower part 20 of the main body 2 toward the ground.

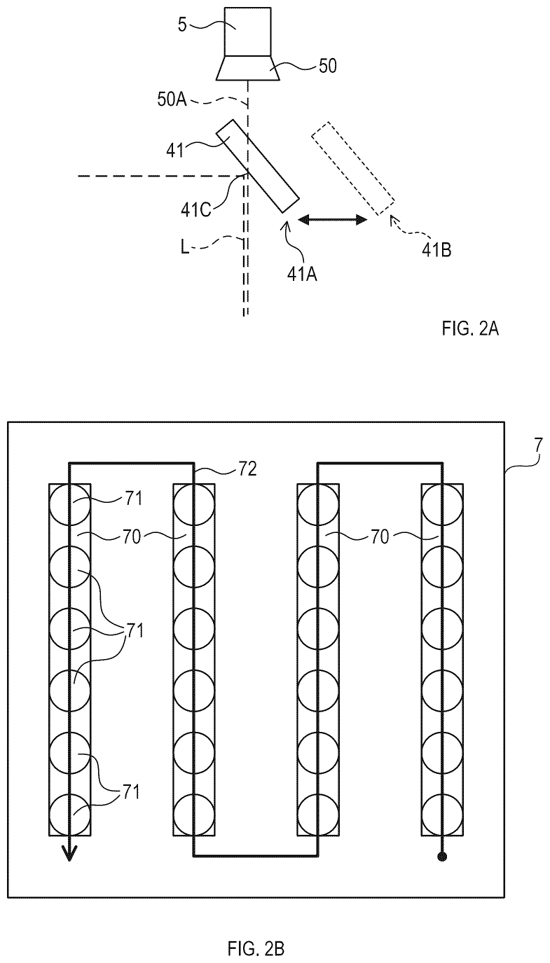

As shown in FIG. 1A, the movable mirror 41 is arranged below the camera 5 and is configured to be displaceable between an interference position 41A and a non-interference position 41B by a not-shown drive mechanism (see FIG. 2A).

The interference position 41A is a position within the imaging range below the camera 5, and the movable mirror 41 in the interference position 41A appears in a captured image taken by the camera 5. The movable mirror 41 in the interference position 41A may be within the image recognition region R (described in detail below) in the captured image taken by the camera 5. As an example, a reflection position 41C of the laser beam L on the movable mirror 41 in the interference position 41A is on or close to an optical axis 50A of the wide-angle lens 50 of the camera 5. Of course, the configuration is not limited to the foregoing, and the interference position 41A may be any position where at least a part of the movable mirror 41 appears within the image recognition region R in the captured image taken by the camera 5.

On the other hand, the non-interference position 41B is a position where the entire movable mirror 41 in the non-interference position 41B does not appear within the image recognition region R in the captured image taken by the camera 5. That is, the movable mirror 41 in the non-interference position 41B does not interfere with the detection of the undesirable plant P located in the image recognition region R by image recognition based on the captured image taken by the camera 5.

### (7) Controller

The controller 6 is a part that comprehensively controls the mobile removal device 1 and includes a CPU and a memory (see FIG. 1A). The CPU executes a program stored in the memory to thereby perform various functions of the mobile removal device 1. Note that the various functions performed by the controller 6 are not achieved solely by the execution of the program. Some or all of the functions may be achieved by one or more hardware components.

In addition, the controller 6 is configured to detect a location (hereinafter, referred to as “current location”) of the mobile removal device 1. Specifically, the controller 6 may detect the current location using, for example, GPS. Alternatively, the controller 6 may detect a speed and a direction of travel of the mobile removal device 1 using a sensor to thereby detect the current location based on these detection results.

### (8) Weeding Operation

The mobile removal device 1 moves on the agricultural land 7 according to path information stored in the memory of the controller 6 and performs a weeding operation. As shown in FIG. 2B, the path information indicates a path 72 along which the mobile removal device 1 moves on the agricultural land 7 and a stop position which is on the path 72 and at which the mobile removal device 1 stops to perform the weeding operation.

As an example, in each ridge 70 of the agricultural land 7, the crops 71 are cultivated at constant intervals (e.g., 60 cm). In the path information in FIG. 2B, the path 72 is set along each ridge 70 as an example, and the mobile removal device 1 moves along the path 72 with the ridge 70 located between the wheels 22.

In the path information, the position of each crop 71 is set as the stop position. When the mobile removal device 1 stops at the stop position, the crop 71 at the stop position is located in the image recognition region R of the mobile removal device 1 (see FIG. 1B). The mobile removal device 1 moves along the path 72, stops at each stop position and weeds around the crop 71.

Specifically, when the mobile removal device 1 stops at the stop position, the controller 6 displaces the movable mirror 41 to the non-interference position 41B (see FIG. 2A), thereby placing the controller 6 in a non-interference state. Then, the controller 6 causes the camera 5 to capture the area of the ground below the main body 2 and image data is generated. At this time, the controller 6 may cause the illuminator 23 to illuminate the imaging range of the camera 5.

The image recognition region R is a part excluding the peripheral area of the image of the ground shown by the image data. Of course, a region to be used as the image recognition region R in the image of the ground shown by the image data is not limited to the foregoing and may be determined as appropriate. The controller 6 performs image recognition of the image recognition region R based on the image data, detects the undesirable plant P in the image recognition region R, and determines XY coordinates at a specified position of the detected undesirable plant P as a target position of the laser beam L.

The controller 6 then displaces the movable mirror 41 to the interference position 41A, thereby placing the controller 6 in an interference state. The controller 6 then sets an irradiation position of the laser beam L based on the determined target position. Specifically, the controller 6 may directly use the XY coordinates of the target position as the irradiation position, or may perform a correction process on the XY coordinates of the target position to thereby obtain XY coordinates and use them as the irradiation position. The controller 6 then controls the galvanometer mirrors 40 to thereby adjust an irradiation direction of the laser beam L, and emits the laser beam L toward the irradiation position. This causes the undesirable plant P to wither and die.

### 2. Second Embodiment

### (1) Overview

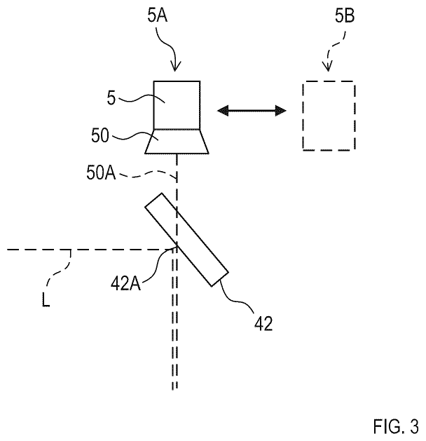

A mobile removal device 1 of a second embodiment differs from the first embodiment in the configuration of the camera 5 and the guide portion 4 (see FIG. 3). Hereinafter, the mobile removal device 1 of the second embodiment is described focusing on differences from the mobile removal device 1 of the first embodiment.

### (2) Camera and Guide Portion

A guide portion 4 of the second embodiment includes a fixed mirror 42 that cannot be displaced, instead of the movable mirror 41 (see FIG. 3). The fixed mirror 42 is configured as a reflector that reflects the laser beam L reflected by the two galvanometer mirrors 40 toward the area of the ground below the main body 2. That is, the laser beam L output by the laser oscillator 3 is finally reflected by the fixed mirror 42 before the laser beam L is emitted from the lower part 20 of the main body 2 toward the ground. The fixed mirror 42 is fixed in a position below the camera 5 in an interference position 5A described below, and this position is the same as the interference position 41A of the movable mirror 41 in the first embodiment.

The camera 5 of the second embodiment includes the wide-angle lens 50 similar to that in the first embodiment. However, the camera 5 of the second embodiment differs from that of the first embodiment in that it is configured to be displaceable between the interference position 5A and a non-interference position 5B by a drive mechanism that is not shown. It is desirable that the interference position 5A and the non-interference position 5B are close to each other.

When the camera 5 is in the interference position 5A, the fixed mirror 42 is located within the imaging range of the camera 5, and appears in the captured image taken by the camera 5. As an example, when the camera 5 is in the interference position 5A, as in the first embodiment, the reflection position 42A of the laser beam L on the fixed mirror 42 is on or close to the optical axis 50A of the camera 5. Of course, the interference position 5A is not limited to the foregoing, and may be any position where at least a part of the fixed mirror 42 appears in the image recognition region R in the captured image taken by the camera 5.

On the other hand, when the camera 5 is in the non-interference position 5B, the entire fixed mirror 42 does not appear in the image recognition region R in the captured image taken by the camera 5. In this case, the fixed mirror 42 does not interfere with the detection of the undesirable plant P located in the image recognition region R by the image recognition based on the captured image taken by the camera 5.

### (3) Weeding Operation

The weeding operation at the stop position in the second embodiment differs from the first embodiment with respect to the control of the camera 5. That is, when the mobile removal device 1 stops at the stop position, the controller 6 displaces the camera 5 to the non-interference position 5B (see FIG. 3), thereby placing the controller 6 in a non-interference state. In the same way as in the first embodiment, the controller 6 then causes the camera 5 to capture an image to generate image data, performs the image recognition of the image recognition region R based on the image data, detects the undesirable plant P, and determines the XY coordinates indicating the target position of the laser beam L.

The controller 6 then displaces the camera 5 to the interference position 5A, thereby placing the controller 6 in the interference state. In the same way as in the first embodiment, the controller 6 then sets the irradiation position of the laser beam L based on the obtained target position, controls the galvanometer mirrors 40, and emits the laser beam L toward the irradiation position.

### 3. Effects

According to the first and second embodiments, in the non-interference state, the detection of the undesirable plant P based on the captured image taken by the camera 5 can be performed without interference. Therefore, it is possible to optimally detect the undesirable plant P based on the captured image.

In the interference state, the reflection position of the laser beam L on the movable mirror 41 or the fixed mirror 42 can be arranged in or close to the imaging range of the camera 5 in the non-interference state. Thus, an origin of the XY coordinates for detecting the position of the undesirable plant P in the image recognition region R of the captured image can be coincident with or close to an origin of the XY coordinates for determining the irradiation position of the laser beam L. As a result, the XY coordinates of the specified position (i.e., the target position) of the undesirable plant P can be directly used as the XY coordinates of the irradiation position of the laser beam L. Alternatively, it is also possible to perform a simple correction process on the target position and then use the resultant XY coordinates of the irradiation position of the laser beam L. Accordingly, the processing required to control the irradiation position of the laser beam L can be reduced.

Therefore, it is possible to optimally control the irradiation position of the laser beam L.
(2) In the first and second embodiments, the camera 5 captures the ground with the wide-angle lens 50. This allows a single camera 5 to capture the ground over a larger area. As a result, it is possible to reduce the number of cameras 5 and simplify the configuration of the mobile removal device 1.
(3) In the first embodiment, the displacement of the movable mirror 41 causes transitions between the interference state and the non-interference state. This allows the interference state and the non-interference state to be optimally switched.

The reflection position of the laser beam L on the movable mirror 41 in the interference state can be arranged in the imaging range of the camera 5 when the undesirable plant P is detected (i.e., in the non-interference state). Thus, the origin of the XY coordinates for grasping the position of the undesirable plant P based on the captured image can be coincident with or closer to the origin of the XY coordinates for determining the irradiation position of the laser beam L. Thus, it is possible to reduce the processing required to control the irradiation position of the laser beam L.
(4) In the first embodiment, in the interference state, the reflection position 41C of the laser beam L on the movable mirror 41 is on or close to the optical axis 50A of the wide-angle lens 50 of the camera 5. As a result, the origin of the XY coordinates for grasping the position of the undesirable plant P based on the captured image can be coincident with or closer to the origin of the XY coordinates for determining the irradiation position of the laser beam L. This reduces the processing required to control the irradiation position of the laser beam L.
(5) In the first and second embodiments, the laser beam L is visible light. Thus, it is possible to optimally control the irradiation position of the laser beam L.

### 4. Other Embodiments

(1) In the first and second embodiments, the mobile removal device 1 is configured to irradiate the undesirable plant P with the laser beam L to thereby remove the undesirable plant P. However, the mobile removal device 1 is not limited to the foregoing and may be configured to remove hindrances other than plants by irradiating the hindrances with the laser beam L. Note that the hindrances are objects that may inhibit the growth of the crop 71, and as an example, pests can be the hindrances.
(2) In the first and second embodiments, the mobile removal device 1 is configured to move on the ground. However, the mobile removal device 1 may be configured as a drone, for example, and may be configured to remove the hindrances such as the undesirable plant P while flying over the agricultural land 7 along a path similar to that of the first and second embodiments.
(3) In the first and second embodiments, the camera 5 is provided with the wide-angle lens 50. However, the camera 5 may be provided with a normal lens that is not the wide-angle lens 50. In this case, the laser beam L may be finally reflected by a reflector provided separately from the movable mirror 41 or the fixed mirror 42, instead of being finally reflected by the movable mirror 41 or the fixed mirror 42, before the laser beam L is emitted from the lower part 20 of the main body 2. In other words, the guide portion 4 may include a reflector which is different from the movable mirror 41 or the fixed mirror 42 and on which the laser beam L is finally reflected before being emitted.
(4) The mobile removal device 1 of the first embodiment may further be configured such that the camera 5 is displaceable. The mobile removal device 1 of the second embodiment may include a movable mirror in place of the fixed mirror 42. In each mobile removal device 1, the controller 6 may displace both the camera 5 and the movable mirror to thereby transition between the interference state and the non-interference state.
(5) In the mobile removal device 1 of the first and second embodiments, the main body 2 may further include a wall (not shown). The wall is a wall-shaped portion protruding from the edge of the lower part 20 of the main body 2 and surrounding the area of the ground below the main body 2. The camera 5 may be configured to capture the area of the ground surrounded by the wall.
(6) In the first and second embodiments, the mobile removal device 1 is configured to perform the weeding operation in a state of being stopped at the stop position provided on the path 72 of the agricultural land 7. However, the mobile removal device 1 is not limited to the foregoing, and may be configured to perform the weeding operation in a similar manner while moving along the path 72 without stopping at the stop position.
(7) Two or more functions of one element of the aforementioned embodiments may be achieved by two or more elements, and one function of one element may be achieved by two or more elements. Furthermore, two or more functions of two or more elements may be achieved by one element, and one function achieved by two or more elements may be achieved by one element. A part of the configuration of the aforementioned embodiments may be omitted. Furthermore, at least part of the configuration of the aforementioned embodiments may be added to or replaced with another configuration of the aforementioned embodiments.

### 5. Technical Ideas Disclosed Herein

### [Item 1]

A mobile removal device configured to irradiate, with a laser beam, a hindrance capable of inhibiting plant growth, the mobile removal device comprising:
a camera configured to capture a ground;
a laser oscillator configured to output the laser beam;
a controller configured to detect the hindrance on the ground based on a captured image taken by the camera and to irradiate the hindrance with the laser beam; and
a guide portion configured to guide the laser beam output by the laser oscillator,
the guide portion including a reflector configured to reflect the laser beam,
the controller being configured to displace at least one of the camera and the reflector to thereby transition between an interference state and a non-interference state, the interference state being a state in which the reflector is located within an imaging range of the camera, and the non-interference state being a state in which the reflector does not interfere with a detection of the hindrance based on the captured image, and
the controller being configured to irradiate the hindrance with the laser beam in the interference state, and to detect the hindrance based on the captured image taken by the camera in the non-interference state.

### [Item 2]

The mobile removal device according to Item 1,
wherein the reflector is configured to finally reflect the laser beam output by the laser oscillator, and
wherein the camera is provided with a wide-angle lens.

### [Item 3]

The mobile removal device according to Item 1 or 2,
wherein the controller is configured to displace the reflector to thereby transition between the interference state and the non-interference state.

### [Item 4]

The mobile removal device according to Item 3,
wherein in the interference state, a reflection position of the laser beam on the reflector is on or close to an optical axis of the camera.

### [Item 5]

The mobile removal device according to any one of Items 1 to 4,
wherein the laser beam is visible light.

What is claimed is:

1. A mobile removal device configured to irradiate, with a laser beam, a hindrance capable of inhibiting plant growth, the mobile removal device comprising:
a camera configured to capture a ground;
a laser oscillator configured to output the laser beam;
a controller configured to detect the hindrance on the ground based on a captured image taken by the camera and to irradiate the hindrance with the laser beam; and
a guide portion configured to guide the laser beam output by the laser oscillator,
the guide portion including a reflector configured to reflect the laser beam,
the controller being configured to displace at least one of the camera and the reflector to thereby transition between an interference state and a non-interference state, the interference state being a state in which the reflector is located within an imaging range of the camera, and the non-interference state being a state in which the reflector does not interfere with a detection of the hindrance based on the captured image, and
the controller being configured to irradiate the hindrance with the laser beam in the interference state, and to detect the hindrance based on the captured image taken by the camera in the non-interference state.

2. The mobile removal device according to claim 1,
wherein the reflector is configured to finally reflect the laser beam output by the laser oscillator, and
wherein the camera is provided with a wide-angle lens.

3. The mobile removal device according to claim 1,
wherein the controller is configured to displace the reflector to thereby transition between the interference state and the non-interference state.

4. The mobile removal device according to claim 3,
wherein in the non-interference state, the controller is configured to detect the hindrance based on an image recognition region in the captured image taken by the camera, and
wherein in the non-interference state, the controller is configured to displace the reflector to a non-interference position where the reflector does not appear in the image recognition region of the captured image taken by the camera.

5. The mobile removal device according to claim 3,
wherein in the interference state, a reflection position of the laser beam on the reflector is on or close to an optical axis of the camera.

6. The mobile removal device according to claim 1,
wherein the controller is configured to displace the camera to thereby transition between the interference state and the non-interference state.

7. The mobile removal device according to claim 6,
wherein in the interference state, a reflection position of the laser beam on the reflector is on or close to an optical axis of the camera.

8. The mobile removal device according to claim 1,
wherein the laser beam is visible light.

9. The mobile removal device according to claim 1,
wherein the hindrance is an undesirable plant.
